(19) United States
(12) Patent Application Publication
(10) Pub. No.: US 2004/0228060 A1
(43) Pub. Date: Nov. 18, 2004

(54) Overvoltage and overcurrent protection circuit and telephone interface protection circuit

(75) Inventors: Yoshinobu Fujiwara, Tokyo (JP); Kyokusei Matsuda, Tokyo (JP); Hiroshi Adachi, Tokyo (JP)

Correspondence Address: MORGAN LEWIS & BOCKIUS LLP, 1111 PENNSYLVANIA AVENUE NW, WASHINGTON, DC, 20004, US

(73) Assignee: Uniden Corporation

(21) Appl. No.: 10/457,784

(22) Filed: Jun. 10, 2003

(30) Foreign Application Priority Data
May 14, 2003 (JP) 2003-135390

(51) Int. Cl. H02H 5/04

(52) U.S. Cl. 361/103

(57) ABSTRACT

An object of the present invention is to provide a telephone interface protection circuit that has excellent standards of safety. In order to achieve this, the telephone interface protection circuit according to this invention comprises a voltage limiting element to limit surge voltages to no more than the withstand voltage of the circuit to be protected; and a positive temperature coefficient thermostatic resistor to limit the flow of overcurrents to the circuit to be protected. The voltage limiting element and positive temperature coefficient thermostatic resistor are thermally coupled together. In the event that an overcurrent is continuously supplied from the subscriber telephone lines, even in the zone below the sensitive current, when the terminal voltage of the voltage limiting element exceeds the threshold voltage, the positive temperature coefficient thermostatic resistor receives the heat emitted from the voltage limiting element and shifts the Curie point, ensuring that the circuit to be protected is blocked from the subscriber telephone lines.

### BACKGROUND OF THE INVENTION

1. Field of the Invention

The present invention relates to a protection circuit to protect electronic equipment from transient overvoltages such as surge overvoltages, and continuing flow of overcurrents due to events such as fault contact of commercial power lines with subscriber telephone lines.

2. Description of the Related Art

Since subscriber telephone lines, which are suspended in the air, are sometimes affected by transient entrance of indirect lightning strikes during electrical storms, and since there is also the possibility of a continuing overcurrent flowing in, for a variably long period of time, due to fault contact with commercial power lines, a protection circuit is provided in the interface between telephones and subscriber telephone lines. For this kind of interface protection circuit, as a measure to combat lightning surges, a construction whereby a voltage limiting element such as a varistor element is connected between two subscriber telephone lines, and a construction whereby such an element is connected between a subscriber telephone line and a grounding wire, are already known. When a transient surge voltage greater than the varistor voltage is applied to the subscriber telephone line, the varistor element shifts to conduction mode and absorbs the surge voltage, protecting the telecommunication circuit in the telephone.

On the other hand, a known measure to prevent a telephone heating up or catching alight due to fault contact between a subscriber telephone line and a commercial power line comprises a current limiting element such as a positive temperature coefficient (PTC) thermistor inserted in the interface between the subscriber telephone line and the telephone. When overcurrent flows continuously into the PTC thermistor for a certain length of time, since the input impedance of the interface increases due to the rise in the temperature of the element, the flow of the overcurrent into the telephone can be suppressed.

However, this kind of telephone interface protection circuit is required to have the capability to withstand surge voltages in the case of lightning surges on the one hand, while at the same time preventing equipment from overheating or catching alight in the event of fault contact with commercial power lines on the other hand. In order to fulfill these conflicting requirements, it is extremely restricted to select the voltage limiting element and the current limiting element, and this has given inflexibility of circuit design.

### SUMMARY OF THE INVENTION

Therefore, the object of the present invention is to resolve these sorts of problems and propose an overvoltage and overcurrent protection circuit to safely protect electronic equipment in case of transient overvoltages or continuing overcurrents being supplied into the electronic equipment.

A further object of the present invention is to propose an interface protection circuit to safely protect telephones in the case of surge voltages or continuing overcurrents being supplied to the telephone.

In order to solve the above-mentioned problems, the overvoltage and overcurrent protection circuit of the present invention includes a voltage limiting element to limit transient overvoltages to no more than the withstand voltage of the circuit to be protected, and a positive temperature coefficient thermostatic resistor to limit the flow of overcurrents to the circuit to be protected, with the voltage limiting element and positive temperature coefficient thermostatic resistor being thermally coupled together.

The transient overvoltage can be absorbed by the voltage limiting element, and the continuously supplied overcurrent can be blocked by the PTC effect created by the heat generated by the positive temperature coefficient thermostatic resistor. In particular, since the voltage limiting element and positive temperature coefficient thermostatic resistor are thermally coupled together, when an overcurrent is supplied to the circuit to be protected, the positive temperature coefficient thermostatic resistor not only generates heat itself, but it also receives a supply of heat from the voltage limiting element, ensuringblockage of the circuit.

If the voltage limiting element and the positive temperature coefficient thermostatic resistor are packaged together in a thermally coupled state, a highly reliable overvoltage and overcurrent protection circuit can be provided at low cost.

The telephone interface protection circuit of the present invention is provided in the interface between the telephone's circuit to be protected and the subscriber telephone line, and comprises a voltage limiting element to limit the surge voltage to no more than the withstand voltage of the circuit to be protected, and a positive temperature coefficient thermostatic resistor to limit the flow of overcurrents to the circuit to be protected, with the voltage limiting element and positive temperature coefficient thermostatic resistor being thermally coupled together.

The surge voltage can be absorbed by the voltage limiting element (surge absorbing element), and the continuously supplied overcurrent can be blocked by the PTC effect created by the heat generated by the positive temperature coefficient thermostatic resistor. In particular, since the voltage limiting element and positive temperature coefficient thermostatic resistor are thermally coupled together, when an overcurrent is supplied to the telephone from the subscriber telephone line, the positive temperature coefficient thermostatic resistor not only generates heat itself, but above a prescribed threshold voltage it also receives a supply of heat from the voltage limiting element, lowering the Curie point, and the circuit can be reliably blocked.

For the voltage limiting element, it is desirable to use a varistor element, and for the positive temperature coefficient thermostatic resistor, it is desirable to use a PTC thermistor. Since a varistor element generates a large amount of heat, it can transfer heat efficiently to the PTC thermistor. In addition, since these elements are inexpensive, a highly reliable protection circuit can be realized at low cost.

### BRIEF DESCRIPTION OF THE DRAWINGS

FIG. 1 is a circuit block diagram mainly showing an interface protection circuit;

FIG. 2 is a diagram showing the positional relationship of the voltage limiting element and the positive temperature coefficient thermostatic resistor; and

FIG. 3 is a block diagram showing a packaged overvoltage and overcurrent protection element.

### DESCRIPTION OF THE PREFERRED EMBODIMENTS

Preferred embodiments of the present invention will be described with reference to the drawings.

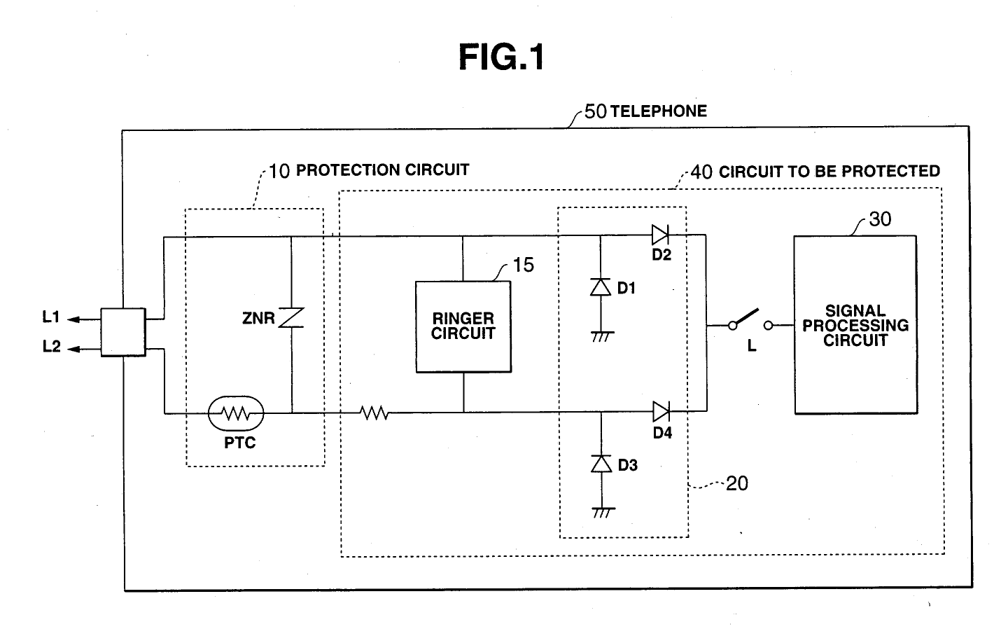

FIG. 1 is a circuit block diagram mainly showing an interface protection circuit for a telephone and subscriber telephone line. As shown in the diagram, inside a telephone 50, an interface protection circuit (overvoltage and overcurrent protection circuit) 10 is provided at the point of contact between subscriber telephone lines L1 and L2, and the circuit to be protected 40. The circuit to be protected 40 includes a signal processing circuit 30 constructed of an IC chip or the like; a diode bridge 20 for rectifying the signal flowing through the subscriber telephone lines L1 and L2 and supplying it to the signal processing circuit 30; and a ringer circuit 15 that drives a speaker when a call is received and generates a ringing sound. The diode bridge 20 is a rectification circuit comprising four diode elements D1 to D4. The relay L is a switch for performing open/close control between the diode bridge 20 and the signal processing circuit 30. During the on-hook condition, the relay L switches the connection between the diode bridge 20 and the signal processing circuit 30 to “open state”, and during the off-hook condition, the relay L switches the connection between the diode bridge 20 and the signal processing circuit 30 to “closed state”. This diagram shows the on-hook condition with the relay L in “open state”.

The telephone interface protection circuit 10 includes a voltage limiting element ZNR to limit transient overvoltages to no more than the withstand voltage of the circuit to be protected 40, and a positive temperature coefficient thermostatic resistor PTC to limit the flow of overcurrents to the circuit to be protected 40. The voltage limiting element ZNR and positive temperature coefficient thermostatic resistor PTC are thermally coupled together, and constructed so that heat generated by the voltage limiting element ZNR can be efficiently transferred to the positive temperature coefficient thermostatic resistor PTC. Transient overvoltages entering the interface of the telephone 50 through the subscriber telephone lines L1 and L2 may be momentary high voltage pulses such as surge voltages. The voltage limiting element ZNR is connected between the subscriber telephone lines L1 and L2 and absorbs surges between these lines. Further, probable causes for a continuing overcurrent being supplied to the interface of the telephone 50 through the subscriber telephone lines L1 and L2 include natural disasters or accidents leading to fault contact of the subscriber telephone lines and commercial power lines. The positive temperature coefficient thermostatic resistor PTC is connected serially with respect to the subscriber telephone line L2, and as well as using its PTC properties of self-heat generation to block the overcurrent, in the zone below the sensitive current of the PTC thermistor, when the terminal voltage of the voltage limiting element ZNR exceeds the threshold voltage, the positive temperature coefficient thermostatic resistor PTC receives the heat generated from the voltage limiting element ZNR and blocks the overcurrent by forcibly shifting the Curie point to the low-temperature side.

For the voltage limiting element ZNR, provided it is an element that absorbs transient overvoltages by conducting above a prescribed threshold voltage and protects the circuit to be protected 40, it is not restricted to any particular element, however, an element that has a high power consumption (high amount of self generated heat) in conduction mode is desirable. For example, a varistor element (nonlinear resistance element) can be used as an element meeting these criteria. In particular, in terms of surge absorption performance, a ZnO varistor element is desirable. For the positive temperature coefficient thermostatic resistor PTC, provided it is an element with PTC properties whereby its resistance value increases as the temperature of the element rises, it is not restricted to any particular element, however, a PTC thermistor such as a Posistor (registered trade name) is desirable.

During the on-hook condition, since the relay L is in “open state”, compared to the situation when the relay L is in “closed state” the input impedance of the telephone 50 with respect to the subscriber telephone lines L1 and L2 is large. Consequently, in the event that an overcurrent flows continuously into the telephone 50 through the subscriber telephone lines L1 and L2, particularly in the on-hook condition, it is necessary to prevent the circuit to be protected 40 from heating up and catching alight. In the on-hook condition, when an overcurrent exceeding the varistor voltage of the voltage limiting element ZNR flows continuously into the telephone interface protection circuit 10, the voltage limiting element ZNR shifts to conduction mode, clamps the terminal voltage and begins to consume the overcurrent. Consumption of the overcurrent also occurs in the positive temperature coefficient thermostatic resistor PTC, and due to the self heat generation effect, the temperature of the element rises. However, since the voltage limiting element ZNR and the positive temperature coefficient thermostatic resistor PTC are thermally coupled together, the positive temperature coefficient thermostatic resistor PTC, in addition to generating heat itself, also receives a supply of heat that is emitted from the voltage limiting element ZNR above a prescribed threshold voltage, and further increases the element temperature.

The positive temperature coefficient thermostatic resistor PTC is made for example from semiconductor ceramics with barium titanate as the principal constituent, and it is known that such resistor exhibits the PTC properties near the Curie point at which there occurs a phase transition from a ferroelectric substance to a paraelectric substance, and the resistance value increases logarithmically (several hundred to several thousand times). When a varistor element is used for the voltage limiting element ZNR, since the amount of heat generated by the varistor element is large, heat can be transferred efficiently to the positive temperature coefficient thermostatic resistor PTC. When an overcurrent has been continuously supplied to the telephone interface protection circuit 10, the positive temperature coefficient thermostatic resistor PTC, in a zone greater than the sensitive current, blocks between the subscriber telephone lines L1 and L2 and the circuit to be protected 40 due to self heat generation by Joule heat. However, even in a zone less than the sensitive current, by receiving a supply of heat from the voltage limiting element ZNR that has shifted to conduction mode, the Curie point can be forcibly lowered and it is possible to block between the subscriber telephone lines L1 and L2 and the circuit to be protected 40, safely and with certainty.

Note that when the flow of the overcurrent from the subscriber telephone lines L1 and L2 to the telephone interface protection circuit 10 ceases, and the element temperature of the positive temperature coefficient thermostatic resistor PTC decreases to below the Curie point, since the protection circuit resets itself to a low resistance, it can be used repeatedly as a resettable fuse.

The circuit connection form of the voltage limiting element ZNR is not limited to the connection form shown in FIG. 1, and may, for example, be connected between the subscriber telephone line L1 and the grounding wire, or between the subscriber telephone line L2 and the grounding wire. Further, in the case that a plurality of voltage limiting elements ZNR are installed, the positive temperature coefficient thermostatic resistor PTC may be thermally coupled to this plurality of voltage limiting elements ZNR.

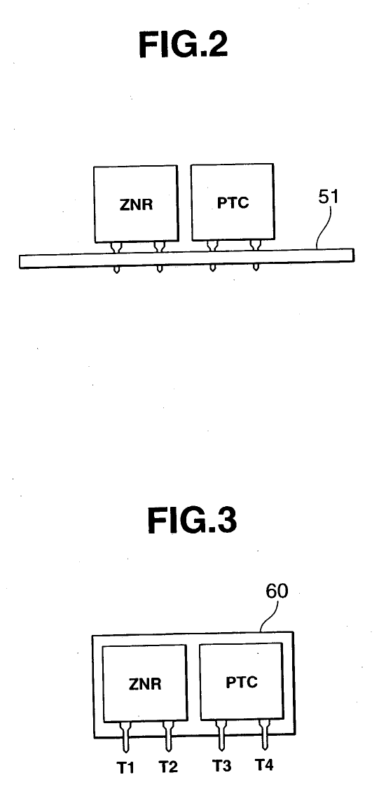

FIG. 2 is a diagram showing the layout of the voltage limiting element ZNR with respect to the positive temperature coefficient thermostatic resistor PTC. As shown in the diagram, the voltage limiting element ZNR and the positive temperature coefficient thermostatic resistor PTC are placed extremely close together on the circuit board 51, and are constituted so that the heat emitted from the voltage limiting element ZNR is transferred efficiently to the positive temperature coefficient thermostatic resistor PTC. In order to couple theremally these elements together, they may be positioned spatially close together, or otherwise a simpler option is to place the elements in contact with each other. However, the present invention is not limited to these options, and for example, thermal coupling may be performed by interposing a heat conducting material with a low thermal resistance between the two elements. In addition, with the two elements in contact with each other or positioned close to each other, the two elements may be enclosed by a thermally coupling material.

FIG. 3 is a block diagram of an overvoltage and overcurrent protection element 60. In the foregoing description, an example was given whereby the telephone interface protection circuit 10 comprised the voltage limiting element ZNR and the positive temperature coefficient thermostatic resistor PTC thermally coupled together. However, the present invention is not limited to this and can be used as an overvoltage and overcurrent protection circuit to protect all sorts of electronic equipment from externally-originating surges and the like. The overvoltage and overcurrent protection element 60 is constructed such that the voltage limiting element ZNR and the positive temperature coefficient thermostatic resistor PTC, in a state thermally coupled together as described above, are combined into a package. In this diagram, T1 to T4 show the input and output terminals of these two elements, however, since the terminal T1 or T2 is connected to the terminal T3 or T4, and they are used as a common terminal, it is also possible to use them as a three-terminal device.

Note that in order for the Joule heat of the voltage limiting element ZNR to be heat transferred to the positive temperature coefficient thermostatic resistor PTC, since it is necessary for an overcurrent to be continuously supplied to the voltage limiting element ZNR, even if a transient overvoltage such as a surge voltage is applied to the voltage limiting element ZNR, this will not give rise to the inconvenient occurrence whereby heat emitted from the voltage limiting element ZNR is transferred to the positive temperature coefficient thermostatic resistor PTC and the circuit is blocked.

As described above, according to the present embodiment, a voltage limiting element and positive temperature coefficient thermostatic resistor that have been conventionally used in a telephone interface protection circuit can produce a sufficient overcurrent blocking effect simply by thermally coupling them together. Therefore, there is no need to use an expensive device such as a Sidac (registered trade name), and an interface protection circuit can be provided that is extremely low cost and highly reliable.

Furthermore, conventionally, a PTC thermistor has been used as a current limiting element to block an overcurrent, however with a PTC thermistor, in order to obtain a desired Curie point, it is necessary to finely adjust the material composition, and this made it easy for variation in the PTC properties to occur. Therefore, the drawback until now has been the possibility that even when the telephone was working normally, the PTC thermistor would block the circuit. In contrast, according to the present embodiment, since the positive temperature coefficient thermostatic resistor PTC and the voltage limiting element ZNR are thermally coupled together, a positive temperature coefficient thermostatic resistor PTC having a current rating slightly larger than the maximum value in normal use can be employed, and even if there is some variation in the PTC properties of the positive temperature coefficient thermostatic resistor PTC, this does not cause any problems.

Further, the voltage limiting element ZNR responds to transient overvoltages such as surge voltages, and the positive temperature coefficient thermostatic resistor PTC responds to continuing overcurrents such as those resulting from fault contact between the subscriber telephone lines and commercial power lines, and since each element can have an optimal element design that is independent of the other, the design freedom of the telephone interface protection circuit 10 is increased. Accordingly, safety standards in countries such as the U.S and Canada (for example UL standards and the FCC rules) can be effectively complied with.

What is claimed is:

1. An overvoltage and overcurrent protection circuit, comprising:
a voltage limiting element to limit transient overvoltages to no more than the withstand voltage of a circuit to be protected; and
a positive temperature coefficient thermostatic resistor to limit the flow of overcurrents to said circuit to be protected,
wherein said voltage limiting element and said positive temperature coefficient thermostatic resistor are thermally coupled together.

2. The overvoltage and overcurrent protection circuit according to claim 1, wherein said voltage limiting element and said positive temperature coefficient thermostatic resistor are combined in a package in a thermally coupled state.

3. The overvoltage and overcurrent protection circuit according to claim 1 or claim 2, wherein said voltage limiting element is a varistor element, and said positive temperature coefficient thermostatic resistor is a PTC thermistor.

4. A telephone interface protection circuit, which is installed in the interface of a telephone between the circuit to be protected and the subscriber telephone lines, comprising:
a voltage limiting element to limit surge voltages to no more than the withstand voltage of said circuit to be protected; and
a positive temperature coefficient thermostatic resistor to limit the flow of overcurrents to said circuit to be protected,
wherein said voltage limiting element and said positive temperature coefficient thermostatic resistor are thermally coupled together.

5. A telephone interface protection circuit according to claim 4, wherein said voltage limiting element is a varistor element, and said positive temperature coefficient thermostatic resistor is a PTC thermistor.
